(19) United States
(12) Patent Application Publication
(10) Pub. No.: US 2017/0050535 A1
(43) Pub. Date: Feb. 23, 2017

(54) MOTOR VEHICLE POWER MANAGEMENT SYSTEM AND METHOD

(71) Applicant: Jean-Pierre Legris, Longueuil (CA)

(72) Inventor: Jean-Pierre Legris, Longueuil (CA)

(73) Assignee: LITO GREEN MOTION INC., Longueuil, QC (CA)

(21) Appl. No.: 14/006,260

(22) PCT Filed: Mar. 23, 2012
(86) PCT No.: PCT/CA2012/000268

§ 371 Date: Mar. 26, 2015

Related U.S. Application Data
(60) Provisional application No. 61/466,660, filed on Mar. 23, 2011.

(51) Int. Cl. B60L 15/20; G01C 21/36; G01C 21/34

(52) U.S. Cl. CPC B60L 15/2045; G01C 21/3469; G01C 21/3667; B60L 2240/622

(57) ABSTRACT

A power management system for a vehicle having at least one motor, comprising a user interface, a global positioning system input, an energy management system input, a motor controller operatively connected to the at least one motor and a power controller operatively connected to the user interface, the global positioning system input, the energy management system input and the motor controller, the power controller being configured to estimate a maximum available power value based on information provided by the user interface, the global positioning system input and the energy management system input. The power controller limits power available to the motor though the motor controller based on the estimated maximum available power.

### CROSS-REFERENCE TO RELATED APPLICATIONS

This application claims the benefits of U.S. provisional patent application No. 61/466,660 filed on Mar. 23, 2011, which is herein incorporated by reference.

### TECHNICAL FIELD

The present disclosure relates to a motor vehicle power management system and method.

### BACKGROUND

Many drivers experience “range anxiety” in a motor vehicle, especially when driving long distances, that is expresses by the fear of not reaching the destination caused by a lack of necessary energy (i.e. gas or electricity). The various motor vehicle gages and indications often indicate how much energy is left or give an estimate of the distance that can be traveled with the available energy but the user must be able to correctly estimate the distance and limit its power consumption (i.e. acceleration, top speed, etc.) in order to reach its destination. Accordingly, there is a need for an adjustable seat support for use with motorcycles, snowmobiles, watercrafts, three and four wheel off-road vehicles, etc.

Accordingly, there is a need for a system that automatically does the above for the driver, leaving him or her to concentrate on its driving.

### SUMMARY

The present disclosure provides a power management system for a vehicle having at least one motor, comprising:

a user interface for receiving a desired destination;

a global positioning system or a global positioning system input for receiving the instant geographical position of the vehicle;

an energy management system or an energy management system input for receiving information regarding the energy reserves of the vehicle;

a motor controller operatively connected to the at least one motor; and

a power controller operatively connected to the user interface, the global positioning system input, the energy management system input and the motor controller, the power controller being configured to compute a maximum available power estimate based on the desired destination, the instant geographical position of the vehicle and the information regarding the energy reserves of the vehicle;

wherein the power controller limits power available to the at least one motor though the motor controller based on the maximum available power estimate.

The present disclosure also provides a power management system as described above, further comprising a conversion table indicating the energy consumption rate of the at least one motor, the power controller using the conversion table for estimating the maximum available power.

The present disclosure further provides a power management system as described above, wherein the power controller includes:

a geolocation application configured to compute the distance from the instant geographical position of the vehicle to the desired destination;

an energy estimation application configured to compute the estimate of the maximum power available to the at least one motor using the conversion table associated the at least one motor, the distance to the desired destination computed by the geolocation application and the information regarding the energy reserves of the vehicle so that the vehicle may safely arrive at the desired destination without running out of energy.

The present disclosure provides as well a power management method for a vehicle having at least one motor, comprising the steps of:

receiving a desired destination;

receiving the instant geographical position of the vehicle;

receiving information regarding the energy reserves of the vehicle;

computing a maximum available power estimate based on the desired destination, the instant geographical position of the vehicle and the information regarding the energy reserves of the vehicle; and limiting the power available to the at least one motor based on the maximum available power estimate.

The present disclosure also provides a power management method as described above, wherein the step of computing a maximum available power estimate includes the sub steps of:

computing the distance from the instant geographical position of the vehicle to the desired destination; and

computing the estimate of the maximum power available to the at least one motor using the conversion table, the distance to the desired destination and the information regarding the energy reserves of the vehicle so that the vehicle may safely arrive at the desired destination without running out of energy.

### BRIEF DESCRIPTION OF THE FIGURES

Embodiments of the disclosure will be described by way of examples only with reference to the accompanying drawings, in which:

FIG. 1 is a schematic representation of the power management system in accordance with an illustrative embodiment of the present disclosure;

FIG. 2 is flow diagram of an illustrative example of the power management process executed by the power management system; and

FIGS. 3A and 3B are graphs of examples of conversion tables for an electric motor (FIG. 3A) and for an internal combustion engine (FIG. 3B).

Similar references used in different Figures denote similar components.

### DEFINITION

The detailed description and figures refer to the following term which is herein defined:

Motor vehicle: a motorcycle, car, bus, truck or any other self propelled vehicle having one or more internal combustion engine (ICE), electric motor or combination thereof, i.e. a hybrid engine/motor.

### DETAILED DESCRIPTION

Generally stated, a non-limitative illustrative embodiment of the present disclosure provides a system that allows the driver of a motor vehicle to reach its desired destination without running out of energy, i.e. electricity coming from a battery pack, gas coming from a gas tank, etc. The system does 50 by limiting the energy that is transferred to the wheels by limiting acceleration, speed and/or energy transfer rate in order to reduce the energy consumption and assure that the motor vehicle reaches its destination.

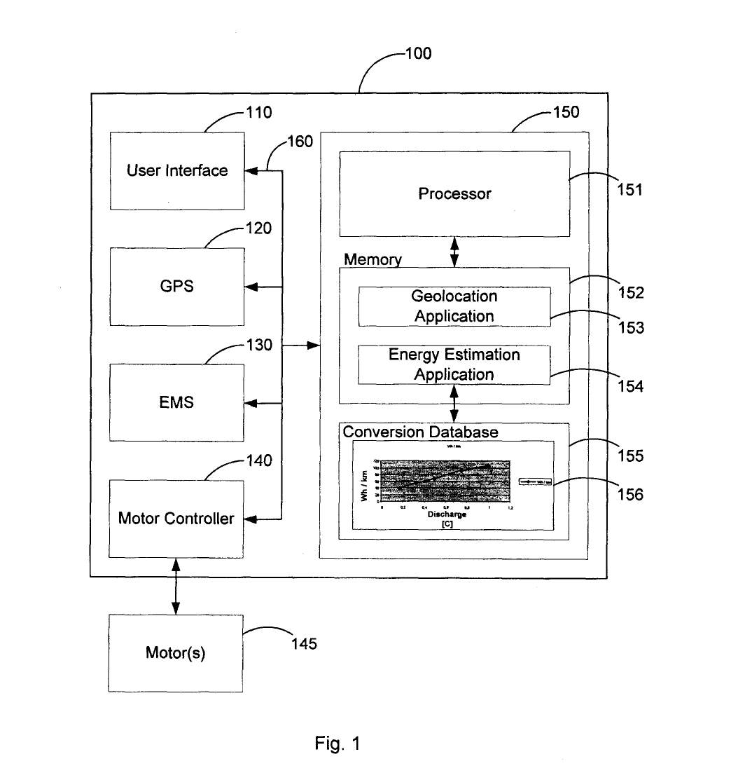

Referring to FIG. 1, the power management system 100 generally comprises a user interface 110, a global positioning system (GPS) 120, an energy management system (EMS) 130, a controller 140 and a power controller 150 in communication through a communication link 160, for example a controller area network (CAN) bus. In an alternative embodiment, the GPS 120 and/or EMS 130 may be replaced by respective GPS and/or EMS inputs for receiving positioning and/or energy reserves information from external systems.

In the illustrative embodiment of the present disclosure, the user interface 110 is in the form of a touch screen with a liquid crystal display (LCD) panel which allows the user to interact with the power controller 150, for example to input a desired destination.

The GPS 120 provides the instant geographical position of the motor vehicle at every instant to the power controller 150.

The EMS 130 provides information regarding the energy reserves of the motor vehicle to the power controller 150. For example, in the case of an electric vehicle, this information would be the charge state of the battery pack in Wh. In the case of an internal combustion engine (ICE), the information would be provided by the fuel gauge in Liter of fuel.

The motor controller 140 limits the power available to the motor(s) 145 of the motor vehicle in response to commands from the power controller 150.

The power controller 150 generally comprises a processor 151, with associated memory 152 having stored therein a geolocation application 153 and an energy estimation application 154, and a conversion database 155 having stored therein one or more conversion tables 156 associated with various motor(s) 145.

The geolocation application 153 is executed by the processor 151 to compute a path and the distance from the instant geographical position of the motor vehicle, as provided by the GPS 120, to a desired destination inputted by the user through the user interface 110.

The energy estimation application 154 is then executed by the processor 151 to compute an estimate of the maximum power available to the motor(s) 145, using the conversion table 156 associated with the motor(s) 145, the distance to the desired destination computed by the geolocation application 153 and the information regarding the energy reserves of the motor vehicle, so that the motor vehicle may safely arrive at the desired destination without running out of energy. This maximum power estimate is provided to the motor controller 140, which limits the power available to the motor(s) 145 accordingly (i.e. acceleration, speed, etc.).

As previously mentioned, the conversion database 155 having stored therein one or more conversion tables 156 indicating the energy consumption (i.e. discharge or injection) rate associated with various motors, including considerations for components between the motor controller 140 and the motor(s) 145.

In an alternative embodiment, the power management system 100 may be designed for a given motor vehicle with a specific motor type. Accordingly, there would be only one conversion table 156 corresponding to the specific motor used, in which case a database may no be required. Furthermore, even in the case where more than one conversions table 156 is present, these may simply be stored in memory instead of in a dedicated database.

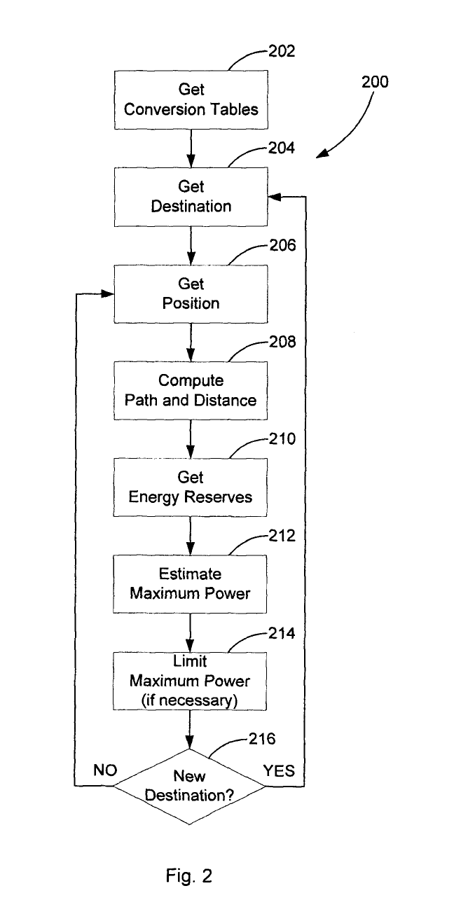

Referring now to FIG. 2, there is shown a flow diagram of an illustrative example of the power management process 200 executed by the power management system 100. The steps of the process 200 are indicated by blocks 202 to 216.

The process 200 starts at block 202 where the appropriate conversion table 156 for the motor(s) 145 is uploaded to the processor 151.

At block 204, the processor 151 is provided the desired destination of the motor vehicle inputted by the user through the user interface 110, for example by entering its address or postal code.

At block 206, the processor 151 is provided the instant geographical position of the motor vehicle by the GPS 120.

Then, at block 208, the processor 151 executes the geolocation application 153 to compute a path and the distance from the instant geographical position of the motor vehicle, as provided at block 206, to the desired destination inputted at block 204.

At block 210, the processor 151 is provided the information regarding the energy reserves of the motor vehicle by the EMS 130.

At block 212, the processor 151 executes the energy estimation application 154 to estimate the maximum power that can be available to the motor(s) 145, using the conversion table 156 uploaded at block 202, the distance to the desired destination computed at block 208 and the energy reserves provided at block 210, so that the motor vehicle may safely arrive at the desired destination without running out of energy.

The maximum power estimate is then provided, at block 214, to the motor controller 140, which limits the power available to the motor(s) 145 accordingly.

Finally, at block 216, the process 200 verifies if the user has inputted a new destination (or canceled its request), in which case it proceeds back to block 204, and if not, it proceeds back to block 206 where the energy reserves, distance, available power, etc., are constantly monitored and updated.

It is to be understood that, optionally, when steps 204 to 212 are performed the first time for a given desired destination, the user may be informed through the user interface 110 of impacted driving parameters such as maximum speed and available accelerations (e.g. acceleration limited to 50%) and ask him or her to confirm that the power management system 100 is to be activated. The user interface 110 may also be used at any time to disengage the power management system 100 or set a new desired destination.

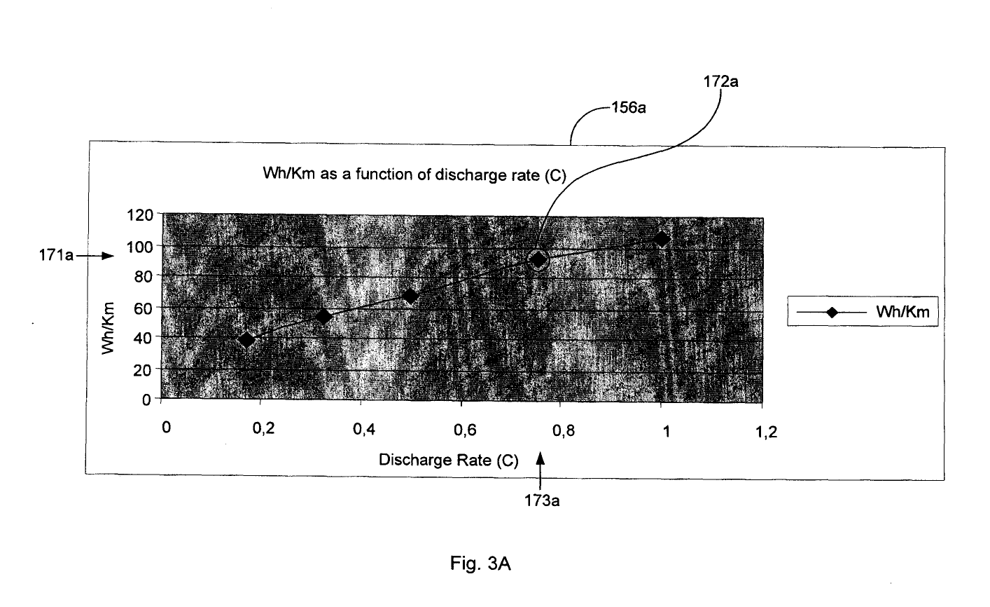

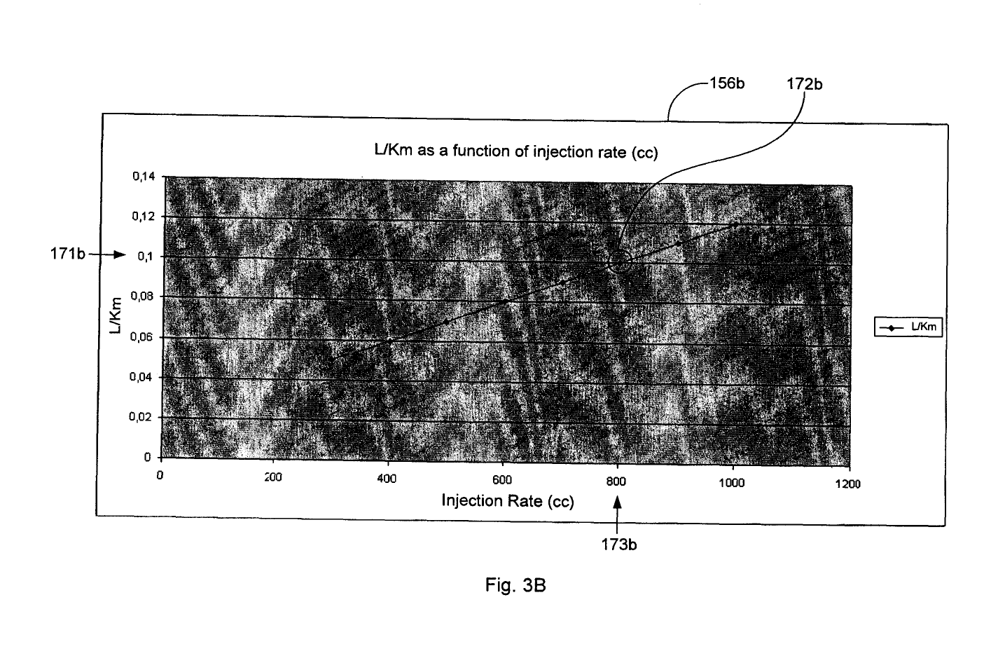

Referring now to FIGS. 3A and 3B, there are shown graphs of examples of conversion tables 156a and 156b for, respectively, an electric motor (FIG. 3A) and for an internal combustion engine (FIG. 3B).

With reference to FIG. 3A, supposing that the distance to the desired destination computed at block 208 is 100 km and the energy reserves provided at block 210 is 95 Wh, for a Wh/Km ratio of 95, indicated by position 171a, then the discharge rate curve would be intersected at point 172a, which would indicate a maximum discharge rate (C) indicated by position 173a.

With reference to FIG. 3B, supposing that the distance to the desired destination computed at block 208 is 100 km and the energy reserves provided at block 210 is 10 L, for a L/Km ratio of 0.1, indicated by position 171b, then the discharge rate curve would be intersected at point 172b, which would indicate a maximum injection rate (cc) indicated by position 173b.

Although the present disclosure has been described with a certain degree of particularity and by way of illustrative embodiments and examples thereof, it is to be understood that the present disclosure is not limited to the features of the embodiments described and illustrated herein, but includes all variations and modifications within the scope and spirit of the disclosure as hereinafter claimed.

1. A power management system for a vehicle having at least one motor, comprising:
a user interface for receiving a desired destination;
a global positioning system input for receiving the instant geographical position of the vehicle;
an energy management system input for receiving information regarding the energy reserves of the vehicle;
a motor controller operatively connected to the at least one motor; and
a power controller operatively connected to the user interface, the global positioning system input, the energy management system input and the motor controller, the power controller being configured to compute a maximum available power estimate based on the desired destination, the instant geographical position of the vehicle and the information regarding the energy reserves of the vehicle;
wherein the power controller limits power available to the at least one motor though the motor controller based on the maximum available power estimate.

2. A power management system in accordance with claim 1, further comprising a global positioning system operatively connected to the global positioning system input,

3. A power management system in accordance with claim 1, further comprising an energy management system operatively connected to the energy management system input,

4. A power management system in accordance with claim 1, further comprising a conversion table indicating the energy consumption rate of the at least one motor, the power controller using the conversion table for estimating the maximum available power.

5. A power management system in accordance with claim 1, further comprising a plurality of conversion tables indicating the energy consumption rate of various motors, the power controller using the conversion table associated with the motor of the vehicle for estimating the maximum available power.

6. A power management system in accordance with claim 4, further comprising a database having stored therein the conversion tables.

7. A power management system in accordance with claim 4, wherein the power controller includes:
a geolocation application configured to compute the distance from the instant geographical position of the vehicle to the desired destination;
an energy estimation application configured to compute the estimate of the maximum power available to the at least one motor using the conversion table associated the at least one motor, the distance to the desired destination computed by the geolocation application and the information regarding the energy reserves of the vehicle so that the vehicle may safely arrive at the desired destination without running out of energy.

8. A power management system for a vehicle having at least one motor, comprising:
a user interface for receiving a desired destination;
a global positioning system providing the instant geographical position of the vehicle;
an energy management system providing information regarding the energy reserves of the vehicle;
a motor controller operatively connected to the at least one motor; and
a power controller operatively connected to the user interface, the global positioning system, the energy management system and the motor controller, the power controller including:
a conversion table associated with the at least one motor; and
a processor with an associated memory having stored therein:
a geolocation application configured to be executed by the processor to compute the distance from the instant geographical position of the vehicle provided by the global positioning system to the desired destination;
an energy estimation application configured to he executed by the processor to compute an estimate of the maximum power available to the at least one motor using the conversion table, the distance to the desired destination computed by the geolocation application and the information regarding the energy reserves of the vehicle so that the vehicle may safely arrive at the desired destination without running out of energy;
wherein the power controller limits power available to the at least one motor though the motor controller based on the maximum available power estimate.

9. A power management system in accordance with claim 8, wherein the conversion table is stored in the memory.

10. A power management system in accordance with claim 8, wherein the conversion table is stored in a database.

11. A power management method for a vehicle having at least one motor, comprising the steps of:
receiving a desired destination;
receiving the instant geographical position of the vehicle;
receiving information regarding the energy reserves of the vehicle;
computing a maximum available power estimate based on the desired destination, the instant geographical position of the vehicle and the information regarding the energy reserves of the vehicle; and
limiting the power available to the at least one motor based on the maximum available power estimate. 12, (original) A power management method in accordance with claim 11, further comprising the step of determining the instant geographical position of the vehicle,

13. A power management method in accordance with claim 11, further comprising the step of generating information regarding the energy reserves of the vehicle

14. A power management method in accordance with claim 11, wherein the step of computing a maximum available power estimate uses a conversion table indicating the energy consumption rate of the at least one motor.

15. A power management method in accordance with claim 14, wherein the step of computing a maximum available power estimate includes the sub steps of
computing the distance from the instant geographical position of the vehicle to the desired destination; and
computing the estimate of the maximum power available to the at least one motor using the conversion table, the distance to the desired destination and the information regarding the energy reserves of the vehicle so that the vehicle may safely arrive at the desired destination without running out of energy,

16. A power management system in accordance with claim 5, further comprising a database having stored therein the conversion tables.

17. A power management system in accordance with claim 5, wherein the power controller includes:
a geolocation application configured to compute the distance from the instant geographical position of the vehicle to the desired destination;
an energy estimation application configured to compute the estimate of the maximum power available to the at least one motor using the conversion table associated the at least one motor, the distance to the desired destination computed by the geolocation application and the information regarding the energy reserves of the vehicle so that the vehicle may safely arrive at the desired destination without running out of energy.
